(19) United States
(12) Patent Application Publication
(10) Pub. No.: US 2004/0200666 A1
(43) Pub. Date: Oct. 14, 2004

(54) Safety restraint apparatus and method

(76) Inventors: Frederick J. Diggle, Birmingham, AL (US); Paul B. Rivers, Cullman, AL (US); Robert C. Hogeland, Fultondale, AL (US)

Correspondence Address: KIRKPATRICK & LOCKHART LLP, 535 SMITHFIELD STREET, PITTSBURGH, PA, 15222, US

(21) Appl. No.: 10/409,013

(22) Filed: Apr. 8, 2003

(51) Int. Cl. A62B 35/00

(52) U.S. Cl. 182/9; 182/134

(57) ABSTRACT

A safety restraint secures a technician to a pole during elevated line work. The safety restraint generally may be structured and arranged to keep a technician from falling if the gaffs of the technician cut out from the pole.

### TECHNICAL FIELD

The present invention relates generally to equipment and methods for preventing a technician from sustaining injury and, more particularly, to a safety restraint apparatus and method for securing a technician to a pole during elevated line work.

### BACKGROUND

Technicians, such as linemen, often are required to climb a telephone pole to install new equipment or to repair broken or damaged communications equipment. To safely and effectively climb a pole and perform line work requires a great deal of skill and technique. Technicians also must maintain and properly utilize various types of climbing equipment used during climbing and performing line work.

Conventional climbing equipment employed by technicians may include a pair of gaffs, a body belt, and a safety strap. In general, each gaff is a sharp blade secured to the leg of a technician and protruding at heal level. To climb, the technician drives one of the gaffs into the pole, steps up onto the gaff, and then drives the other gaff into the pole at a higher position. The technician continues taking steps up or “gaffs up” the pole until reaching a desire height.

The body belt is secured around the waist of the technician and includes pockets for carrying tools and rings (e.g., D-rings) for attaching the safety strap. The safety strap typically includes a hook (e.g., snap buckle) at each end and a buckle for adjusting its length. During climbing, both hooks of the safety strap are attached to the same ring of the body belt on the left hip. Once in a position to perform line work, the technician releases one end of the safety strap from the body belt and wraps the safety strap around the pole. The technician then reattaches the end of the safety strap to the right D-ring on the body belt, thus securing the technician to the pole.

During elevated line work, both gaffs are pressed into the pole and the technician leans back against the safety strap. This position allows the weight of the technician to be supported by the gaffs and the tension in the safety strap. An error in technique or defect in equipment, however, can result in serious injury to the technician. For example, there are times when a gaff dislodges or “cuts out” from the pole. If one or both of the gaffs cuts out, the technician may fall straight down from atop the pole.

To avoid the risk of injury, some technicians have resorted to using only ladders or bucket trucks to perform elevated line work. This solution requires the purchase and maintenance of additional equipment and, thus, results in increased expenses for the technician's employer. In addition, work-related injuries still occur frequently when using and transporting a ladder of the size necessary to reach the top of a pole.

Accordingly, there exits the need for equipment and methods for allowing a technician to safely perform elevated line work by preventing the technician from falling if the gaffs of the technician cut out from the pole.

### SUMMARY

In one general aspect, a safety restraint apparatus includes a strap portion having a first end and a second end and a locking member for attaching the first end and the second end to form a loop. The loop may extend around an elevated portion of a pole, the proposed belt portion may secure the safety strap to the pole, and the safety strap may attach to a body belt of a technician.

Implementations may include one or more of the following features. For example, the technician may be secured to the pole by the safety strap and at least one gaff having a blade portion extending into the pole. The safety restraint apparatus may be structured and arranged to keep the technician from falling from the elevated portion of the pole in the event that the blade portion dislodges from the pole. Contact between the safety strap and the pole may be maintained by the proposed belt portion in the event that the blade portion dislodges from the pole.

The safety restraint may include an adjustment portion for adjusting size the loop. In some cases, the adjustment portion may be integral with the belt portion. The safety restraint may include an overlapping portion in contact with an outer surface of the safety strap and an underlying portion in contact with the pole. The underlying portion may contact an inner surface of the safety strap.

The belt portion may be made of nylon webbing, polypropylene webbing, reinforced fabric, leather, polyester, plastic, rubber, metal, and/or a combination thereof. In some implementations, the belt portion may include a chain. The belt portion may be separate from or integral with the safety strap. The locking member may include a buckle assembly and/or a latching hook assembly, or an S-hook.

In another general aspect, a safety restraint method includes attaching a safety restraint so as to secure a safety strap to a pole. The safety strap may be attached to a body belt of a technician. The safety restraint may include a belt portion having a first end and a second end and a locking member for attaching the first end and the second end.

Implementations may include one or more of the following features. For example, attaching the safety restraint may involve guiding the belt portion of the safety restraint around the pole and once through a loop formed by the safety strap and the body belt, attaching the first end of the belt portion to the second end of the belt portion, and adjusting the belt portion to tighten the safety restraint.

The safety restraint method may include ascending the pole, reaching a desired height, and/or securing the safety strap. Ascending the pole may involve driving a first gaff into the pole, stepping up onto the first gaff, and/or driving a second gaff into the pole at a higher position. The desired height may be a position suitable for performing line work. Securing the safety strap may involve releasing a first end of the safety strap from the body belt, wrapping the safety strap around the pole, and reattaching the first end of the safety strap to the body belt.

In another general aspect, a safety assembly includes a safety strap extending around an elevated portion of a pole and attached to a body belt of a technician. The technician may be secured to the pole by the safety strap and at least one gaff having a blade portion extending into the pole. The safety assembly also includes means for securing the safety strap to the pole and for preventing the technician from falling from the elevated portion of the pole in the event that the blade portion dislodges from the pole.

Other features and advantages will be apparent from the following description, including the drawings, and from the claims.

### DESCRIPTION OF THE FIGURES

FIGS. 1A and 1B illustrate one embodiment of a safety restraint apparatus.

FIG. 2 illustrates one embodiment of a safety restraint apparatus.

FIG. 3 illustrates one embodiment of a safety restraint apparatus.

FIG. 4 is a flowchart of one embodiment of a safety restraint method.

### DETAILED DESCRIPTION

In one aspect, a pole safety restraint secures a technician to a pole during elevated line work. The pole safety restraint generally may be structured and arranged to keep a technician from falling if the gaffs of the technician cut out from the pole.

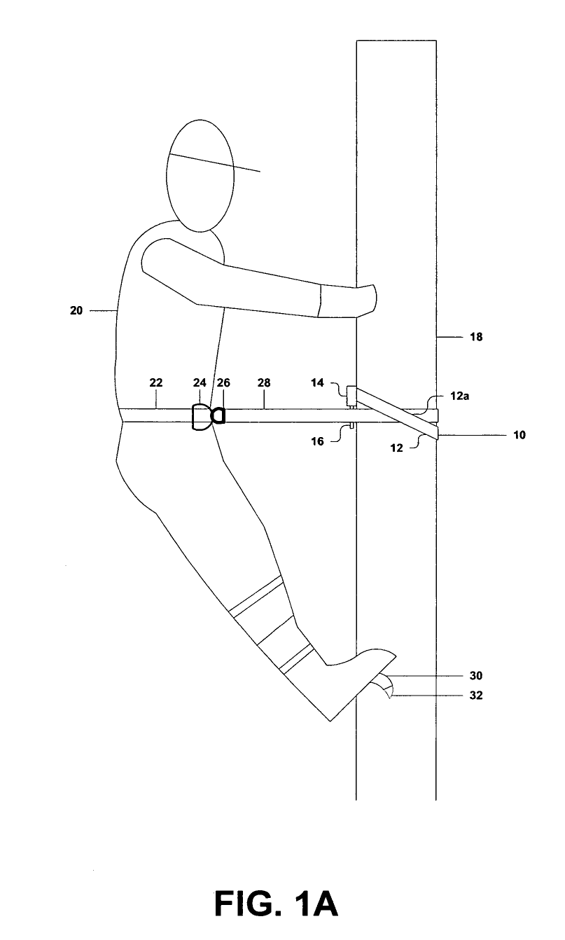

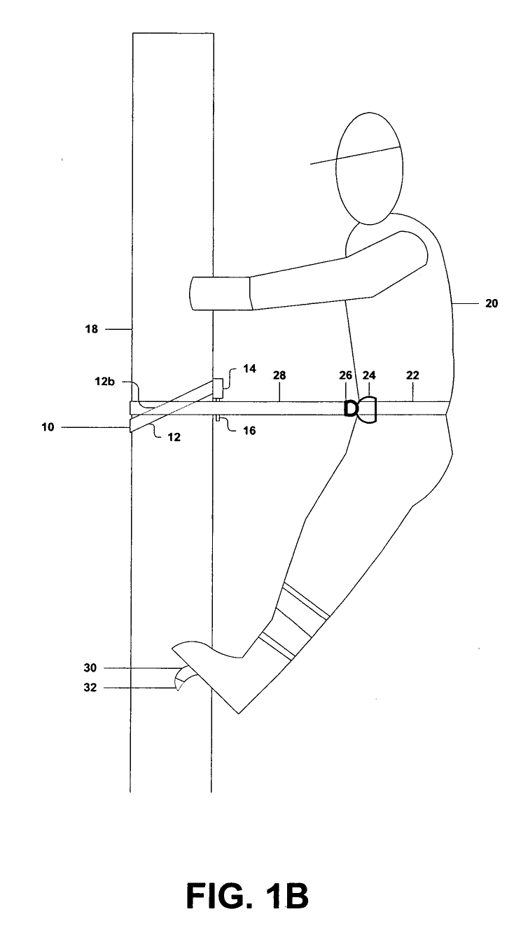

FIGS. 1A and 1B illustrate one embodiment of a pole safety restraint 10. As shown, the pole safety restraint 10 may include a belt portion 12 and a locking member 14. In general, the belt portion 12 may be made of any type of flexible material having sufficient tensile strength to safely support the weight a technician. Examples include, but are not limited to, nylon or polypropylene webbing, reinforced fabric, leather, polyester, plastic, rubber, metal and/or combination thereof While the dimensions may vary depending upon the particular implementation, in one embodiment, the belt portion 12 may be approximately one-inch wide.

The locking member 14 may be any type of device configured to secure ends of the belt portion 12 together to form a loop. In general, the type of locking member 14 that is used may depend on the particular implementation of the belt portion 12. For example, in embodiments in which the belt portion 12 is made of webbing (e.g., seat belt material) or leather, the locking member 14 may include a buckle assembly (e.g., two-piece buckle, post and hole) or a latching-hook assembly (e.g., sewn-in steel ring and S-hook or clevis slip hook). In an embodiment in which the belt portion 12 includes interconnected metal chain links, the locking member 14 may include an S-hook.

In some implementations, the size of the loop formed by the belt portion 12 may be adjusted. As shown in FIGS. 1A and 1B, the safety restraint 10 may include an adjustment portion 16 that may be connected to and/or formed integrally with the belt portion 12. In one embodiment, pulling and/or lengthening the adjustment portion 12 causes the loop formed by the belt portion 12 to tighten around a pole 18, for example.

When positioned on a pole 18 to perform elevated line work, a technician 20 may utilize the pole safety restraint 10. Examples of elevated line work include, but are not limited to installation, maintenance, and/or repair of serving terminals, wire pouches, J-hooks, network cable, and/or other communications equipment. In general, the pole 18 may be any type of utility pole such as a telephone pole, for instance. In most cases, the pole 18 will be tapered, i.e. the diameter of an upper portion of pole 18 is smaller than the diameter of a lower portion of the pole 18.

As shown, the technician 20 may wear a body belt 22 secured about the waist. The body belt 22 may include a pair of locking members 24 (e.g., D-rings) for engaging corresponding attachment members 26 on the ends of a safety strap 28. The safety strap 28 may extend around the pole 18 and connect with the body belt 22 worn by the technician 20. When the locking members 24 of the body belt 22 are engaged with the corresponding attachment members 26 of the safety strap 28, the technician 20 is secured to the pole 18.

The technician 20 also may wear a pair of gaffs 20. As depicted in FIGS. 1A and 1B, the gaffs 30 may include blade portions 32 that are driven into the pole 18 by the technician 20. When the technician 20 is in a position to perform elevated line work, the weight of the technician 20 may be supported by the gaffs 26 and by the safety strap 28.

In one aspect, the safety restraint 10 may be structured and arranged to secure the safety strap 28 to the pole 18. As shown in the embodiment of FIGS. 1A and 1B, the safety restraint 10 may include a belt portion 12 wrapped around the pole 18 and a locking member 14 securing together the ends of the belt portion 12. The belt portion 12 thus forms a loop around the pole 18. The size of the loop may be adjusted, for example, by pulling and/or lengthening the adjustment portion 16.

In one implementation, the belt portion 12 of the safety restraint 10 forms a loop configured to secure the safety strap 28 to the pole 18. Referring to FIG. 1A, the belt portion 12 includes an overlapping section 12a that contacts the outer surface of safety strap 28. Referring to FIG. 1B, the belt portion 12 further include an underlying section 12b that contacts the outer surface of the pole 18 and passes to the inside of the safety strap 28. In some cases, the outer surface of the belt portion 12 may be in contact with the inner surface of the safety strap. The size of the loop formed by the belt portion 12 may be adjusted to tighten the safety restraint 10 around the safety strap 28 and the pole 18.

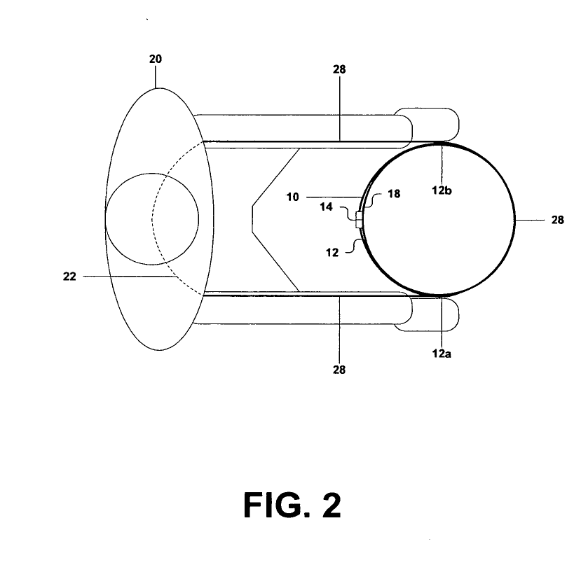

FIG. 2 further illustrates this implementation. As shown, the safety strap 29 and the body belt 22 form a loop when connected to each other. Again, the safety restraint 10 includes a belt portion 12 and a locking member 14. The overlapping section 12a contacts the outer surface of safety strap 28 and the underlying section 12b contacts the outer surface of the pole 18 at a place where the belt portion 12 passes to the inside of the loop formed by the safety strap 28 and the body belt 22.

In this implementation, the belt portion 12 of the safety restraint 10 extends once through the loop formed by the safety strap 28 and the body belt 22 of the technician 20. In other words, the belt portion 12 breaks the plane defined by the loop formed by the safety strap 28 and the body belt 22 only once. In this embodiment, the plane is broken by the underlying section 12b of the belt portion 12.

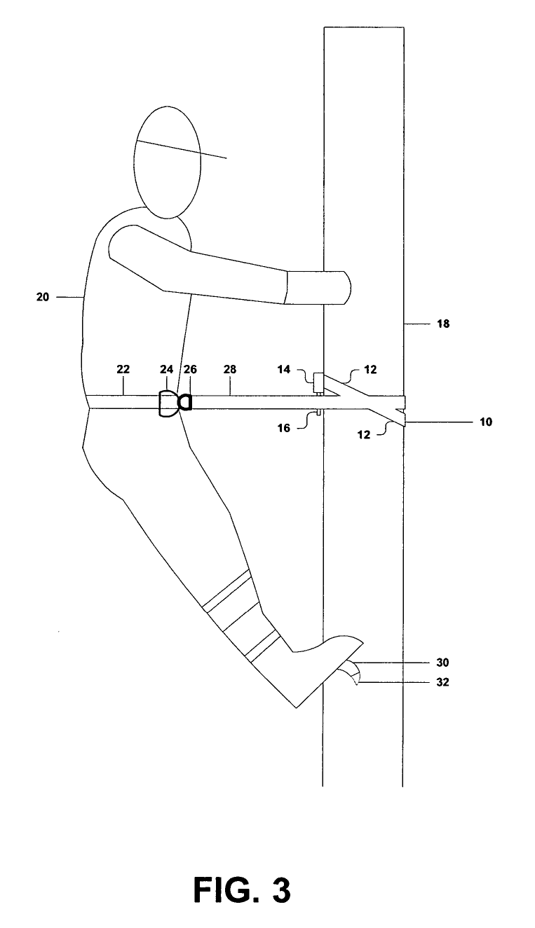

Referring to FIG. 3, an alternative embodiment of a safety restraint is illustrated. As shown, the safety restraint 10 again includes a belt portion 12 and a locking member 14. In this embodiment, however, the belt portion 12 may be connected to and/or formed integrally with the safety strap 28. In general, the belt portion 12 may be made of any type of flexible material having sufficient tensile strength to safely support the weight of the technician 20. Examples include, but are not limited to, nylon or polypropylene webbing, reinforced fabric, leather, polyester, plastic, rubber, metal and/or combination thereof. The material forming the belt portion 12 may be the same as or different from the material forming the safety strap 28. While the dimensions may vary depending upon the particular implementation, in one embodiment, the belt portion 12 may be approximately one-inch wide.

In this embodiment, the belt portion 12 may include an underlying section 12b (see FIG. 1B) that contacts the outer surface of the pole 18 and passes to the inside of the safety strap 28. The size of the loop formed by the belt portion 12 may be adjusted to tighten the safety restraint 10 around the safety strap 28 and the pole 18.

In this embodiment, the belt portion 12 of the safety restraint 10 also may extend once through the loop formed by the safety strap 28 and the body belt 22 of the technician 20. In other words, the belt portion 12 may break the plane defined by the loop formed by the safety strap 28 and the body belt 22 only once. For example, the plane may be broken by the underlying section 12b of the belt portion 12 (see FIG. 1B).

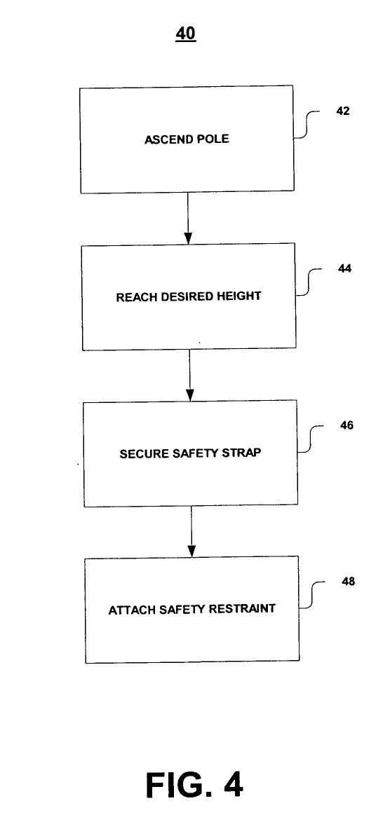

FIG. 4 illustrates a flow chart for one embodiment of a safety restraint method 40 for securing a technician to a pole during elevated line work. In general, the safety restraint method 40 prevents a technician from falling if the gaffs of the technician cut out from the pole.

At step 42, a technician ascends a pole. In one implementation, the technician wears a pair of gaffs and ascends the pole by driving one of the gaffs into the pole, stepping up onto the gaff, and then driving the other gaff into the pole at a higher position. In general, the pole may be any type of utility pole such as a telephone pole, for instance. In most cases, the pole will be tapered, i.e. the diameter of an upper portion of pole is smaller than the diameter of a lower portion of the pole.

In one implementation, the technician also wears a body belt having a safety strap and a safety restraint attached thereto. During climbing, the safety strap and the safety restraint may be hooked on to one or more rings on the body belt.

At step 44, the technician reaches a desired height. In general, the technician continues taking steps up or “gaffs up” the pole until reaching a height suitable for performing elevated line work. Examples of elevated line work include, but are not limited to installation, maintenance, and/or repair of serving terminals, wire pouches, J-hooks, network cable, and/or other communications equipment.

At step 46, the technician secures the safety strap. Once in a position to perform line work, the technician releases one end of the safety strap from the body belt and wraps the safety strap around the pole. The technician then reattaches the end of the safety strap to the body belt, thus securing the technician to the pole. During elevated line work, both gaffs are driven into the pole and the technician leans back against the safety strap. This position allows the weight of the technician to be supported by the gaffs and the tension in the safety strap.

At step 48, the technician attaches the safety restraint. In general, the safety restraint may be structured and arranged to secure the safety strap to the pole. In one implementation, the technician guides the belt portion of the safety restraint around the pole and once through the loop formed by the safety strap and the body belt. The technician then attaches the ends of the safety restraint and cinches it up. For example, the technician may hold one end of the safety restraint to the outside of the safety strap loop, guide the other end of the safety restraint around the back of the pole and up through the safety strap loop, attach both ends of the safety restraint together, and then tighten the safety restraint so as to secure the safety strap to the pole.

In the event that the gaffs of the technician cut out, the safety restraint will prevent the technician from falling from atop the pole. Namely, as the technician begins to fall toward the ground, the safety restraint holds the safety strap in contact with the pole. Since the safety strap is locked to the body belt of the technician, a complete fall is prevented. In most cases, the technician will fall only a short distance before the safety strap catches and swings the technician toward the pole so that the technician can grab the pole and regain footing. Furthermore, even if the safety restraint is not tightened completely, the technician will only descend to a point where the taper of the pole is wide enough to catch and hold the safety restraint.

As described and illustrated, aspects of the present invention provide a way to secure a technician to a pole during elevated line work which keeps the technician from falling if the gaffs of the technician cut out from the pole.

A number of implementations have been described. Nevertheless, it will be understood that various modifications may be made and that other implementations are within the scope of the following claims.

1. A safety restraint apparatus comprising:
a belt portion adapted to secure a safety strap to a pole, the belt portion having a first end and a second end, a surface the belt portion including an underlying section and an overlapping section, the underlying section being adapted to contact an outer surface of the pole, the overlapping section being adapted to contact an outer surface of the safety strap that is not in contact with the outer surface of the pole; and
a locking member for attaching the first end and the second end to form a loop,
wherein the loop can extend around an elevated portion of a the pole, and
the safety strap can attach to a body belt of a technician providing protection from a fall.

2. The safety restraint apparatus of claim 1, wherein the safety restraint apparatus is structured and arranged to keep the technician from falling from the elevated portion of the pole in the event that a blade portion of a gaff securing the technician to the pole dislodges from the pole.

3. The safety restraint apparatus of claim 2, wherein contact between the safety strap and the pole is maintained by the belt portion in the event that the blade portion dislodges from the pole.

4. The safety restraint apparatus of claim 1, further comprising an adjustment portion for adjusting size the loop.

5. The safety restraint apparatus of claim 4, wherein the adjustment portion is integral with the belt portion.

6. (cancelled)

7. The safety restraint apparatus of claim 1, wherein the underlying portion contacts an inner surface of the safety strap.

8. The safety restraint apparatus of claim 1, wherein the belt portion comprises at least one of nylon webbing, polypropylene webbing, reinforced fabric, leather, polyester, plastic, rubber, and metal.

9. The safety restraint apparatus of claim 1, wherein the belt portion comprises a chain.

10. (cancelled)

11. The safety restraint apparatus of claim 1, wherein the locking member comprises at least one of a buckle assembly and a latching hook assembly.

12. A safety restraint method comprising:
attaching a safety restraint so as to secure a safety strap to a pole, the safety strap being attached to a body belt of a technician and the safety restraint including:
a belt portion adapted to secure a safety strap to a pole, the belt portion having a first end and a second end, a surface the belt portion including an underlying section and an overlapping section, the underlying section being adapted to contact an outer surface of the pole, the overlapping section being adapted to contact an outer surface of the safety strap that is not in contact with the outer surface of the pole; and
a locking member for attaching the first end and the second end.

13. The safety restraint method of claim 12, wherein attaching the safety restraint comprises:
guiding the belt portion of the safety restraint around the pole and once through a loop formed by the safety strap and the body belt;
attaching the first end of the belt portion to the second end of the belt portion; and
adjusting the belt portion to tighten the safety restraint.

14. The safety restraint method of claim 12, further comprising ascending the pole.

15. The safety restraint method of claim 14, wherein ascending the pole comprises driving a first gaff into the pole, stepping up onto the first gaff, and then driving a second gaff into the pole at a higher position.

16. The safety restraint method of claim 12, further comprising reaching a desired height.

17. The safety restraint method of claim 16, wherein the desired height is suitable for performing line work.

18. The safety restraint method of claim 12, further comprising securing the safety strap.

19. The safety restraint method of claim 17, wherein securing the safety strap comprises:
releasing a first end of the safety strap from the body belt;
wrapping the safety strap around the pole; and
reattaching the first end of the safety strap to the body belt.

20. A safety assembly comprising:
a safety strap extending around an elevated portion of a pole and attached to a body belt of a technician, the technician being secured to the pole by the safety strap and at least one gaff having a blade portion extending into the pole; and
means for securing the safety strap to the pole and for preventing the technician from falling from the elevated portion of the pole in the event that the blade portion dislodges from the pole, said means including a belt portion having a surface including an underlying section and an overlapping section, the underlying section being adapted to contact an outer surface of the pole, the overlapping section being adapted to contact an outer surface of the safety strap that is not in contact with the outer surface of the pole.
